(19) United States
(12) Patent Application Publication
(10) Pub. No.: US 2013/0305699 A1
(43) Pub. Date: Nov. 21, 2013

(54) VERSATILE KINETIC ENERGY RECOVERY DEVICE

(71) Applicant: RUDOLPH NATHANIEL BRISSETT, KINGSTON (JM)

(72) Inventor: RUDOLPH NATHANIEL BRISSETT, KINGSTON (JM)

(21) Appl. No.: 13/459,214

(22) Filed: Apr. 29, 2012

Related U.S. Application Data
(60) Provisional application No. 61/481,208, filed on May 1, 2011.

(51) Int. Cl. F15B 15/00

(52) U.S. Cl. CPC F15B 15/00
USPC 60/327; 60/325

(57) ABSTRACT

Described herein is a device, process, and system for the transformation of kinetic energy from one form to a more appropriately useful form. The single inventive concept utilizes compressed fluid and has the ability to transform energy from traffic including motorized traffic, from wave or ocean power on or within the ocean, from any animate object which may activate it. Energy may also be harvested from machines in motion.

Numerous uses including industrial, recreational or around the home may be made of this invention. The essential components involve an actuator which activates a radial outflow reaction turbine, where the turbine may also have internal compressed storage utilised in causing rotation of said turbine.

### TECHNICAL FIELD

The invention relates to a versatile kinetic energy recovery device for capturing and converting energy to an appropriately useful form.

More specifically, though not exclusively, the invention pertains to energy harvesting which is the capturing and converting of energy to more appropriately useful forms of energy from the following sources: ocean forces, and motive forces using the same inventive concept.

Motive forces refers to forces experienced when in motion due to the motion of animals, carriages, vehicles, cycles, trains, flying vessels, humans, or machines,e.g., valves which repetitively open and close during operation and humans walking generates compressive forces which may be utilised in this invention.

### BACKGROUND OF THE INVENTION

The imminent shortage of conventional fossil fuel is driving the need to develop alternative renewable energy and kinetic energy recovery devices and systems. These systems and devices usually suffer from one or other of the following: per unit of power produced they are usually very costly and/or have very high initial costs; are quite large, visually and possibly audibly intrusive; and may require large portions of land space in addition to having low efficiencies. Other devices may pump fluid to an energy generator (possibly including a turbine) for this invention the one device which generates the fluid can generates the power. In addition these systems have lacked the demonstrated versatility to capture and convert energy from more than one source using a single inventive concept, this is one of the unique features of this invention.

Inventions from this category include:

U.S. Pat. Nos. 7,781,903; 4,281,257; 4,208,878 and 2008/0315588 teach ocean energy conversion devices based on compressed air or ocean currents to operate a hydraulic motor or electrical generator; and WO 2006/106399 illustrates a vehicular compressed air production device, with an elastomeric actuator, intended to be part of an energy recovery system, similarly WO 2005/005831 which is mechanically more complex.

U.S. Pat. No. 3,879,152 teaches a fluid operated rotating reaction turbine for generation of power, though this invention has an internal cavity it is not used to store while in use compressed fluid to stabalise the power coming from the turbine a unique feature claimed by the invention of this application.

Lawrence Livermore Laboratory. Analysis of a radial-outflow reaction turbine concept for geothermal application [online]. The University of California, May 25, 1978 [retrieved on 2012-27-04]. Retrieved from the Internet: <http://www.osti.gov/bridge/serylets/purl/6548310-h5bK2B/native/6548310.pdf>pp. 1-7, illustrates a radial outflow reaction turbine operated by steam.

This reference also shows Barker's Mill which involves operating a mill by rotating grindstones using water falling from an elevation through a channel and exiting a radial outflow reaction turbine.

Mach, E. The science of mechanics: A critical and historical account of its development [online]. 4th edition. Chicago: The Open Court Publishing Co., 1919 [retrieved on 2012-27-04]. Retrieved from the Internet: <http://books.google.com.jm/books? id=IgYADjGcJcAC&pg=PR3&dq=the+science+of +mechanics: +a+critical+and+historical+account+of +its+development&hl=en&ei=0RycT_PxAo2Wtwe94PmmBA&sa=X&oi=book_result&ct=book-thumbnail&redir_esc=y#v=onepage&q=the %20science %20of%20mechanics%3A %20a %20critical%20and%20historical%20account%20 of%20its %20development&f=false>Chapter 3, pp. 299-300, shows a radial outflow turbine whose rotational behaviour is evaluated when it takes in air and air issues from it, this was a purely non-technological application oriented analysis.

U.S. Pat. No. 4,996,840 teaches an apparatus utilizing a mechanical mechanism for generating rotary motion from rise and fall motion of waves.

### SUMMARY OF THE INVENTION

It is an object of this invention to provide a fluidic apparatus and method from a single inventive concept that is able to recover kinetic energy from varying sources.

It is a further object of this invention to provide a turbine said turbine having integral compressed fluid storage which may be utilised in causing the turbine to rotate even when the turbine is not receiving compressed fluid.

It is yet another object of this invention to provide a power-generator with a rotor in the form of a turbine which rotates due to fluid issuing from it, said turbine having integral compressed fluid storage.

It is also an object of this invention to provide a kinetic energy recovery device which benefits fully from the angular momentum generated by the continuous injection of pressurised fluid to the rotating turbine.

It is still another object of this invention to provide a kinetic energy recovery device for use as an ocean energy recovery device.

It is still a further object of this invention to provide a kinetic energy recovery device for use as a motive forces energy recovery device.

It is still yet another object of this invention to provide a kinetic energy recovery device for use as a shock absorber.

Other objects will become evident on reading this application.

Briefly stated, the invention functions as a versatile kinetic energy recovery device which is actuated to enable energy to be converted from one form to a more appropriately useful form.

For the ocean energy embodiment the actuator, which we will call a Flotation-Unit will be a device which moves with the ocean forces be it that these forces are due to the waves or disturbances within the ocean. When the flotation-unit is on the water surface the major force acting on it is expected to be that of the waves with which it reciprocates, when submerged it may take the form of flaps or other elements which may sway from side to side and move with disturbances of the water.

For the motive forces embodiment the actuator may incorporate an elastomeric element-be it a spring, elastic plate, or otherwise elastic element which is actuated by the moving body putting pressure on it, we shall call this actuator a Compressive Restorative Unit, we will focus on motive traffic for this embodiment.

In order to highlight the versatility and unity of the invention we need to note that the actuator of the kinetic energy recovery device in both the ocean and motive traffic case serve a single purpose and that is to ultimately move fluid, so we shall refer to both these as Pressure-responsive Pumping Elements.

The pressure-responsive pumping elements may also comprise a piston and in the preferred embodiments shown herein they do.

The actuator of the invention is activated to force compressed fluid through a fluid tight passage. Said fluid subsequently enters the radial passage of a rotatory element subsequently exiting, preferably tangentially, an opening within said radial passage thus permitting the rotatory element to rotate and produce energy. This makes the rotatory element a Radial Outflow Reaction Turbine since it rotates due to the reaction of the fluid being ejected from the rotor unlike traditional turbines which have the fluid impinge on or flow pass their blades for them to rotate. The turbine may drive a power-generator.

### BRIEF DESCRIPTION OF THE DRAWINGS

A number of preferred, non-limiting embodiments of the present invention (obvious details have been omitted) will be described by way of example with reference to the accompanying drawings, in which:

FIG. 1 is a simplified block diagram showing the various components of a versatile kinetic energy recovery device system.

FIG. 2 is a cross sectional view of a first embodiment of the invention showing an ocean energy implementation.

FIGS. 3 and 4 illustrate a system and first embodiment of a frontal view of an actuator mechanism for the aforementioned first embodiment of the kinetic energy recovery device.

FIG. 5 is a cross sectional view of a second embodiment of the invention showing a motive forces actuated version of the invention.

### DETAILED DESCRIPTION OF THE INVENTION

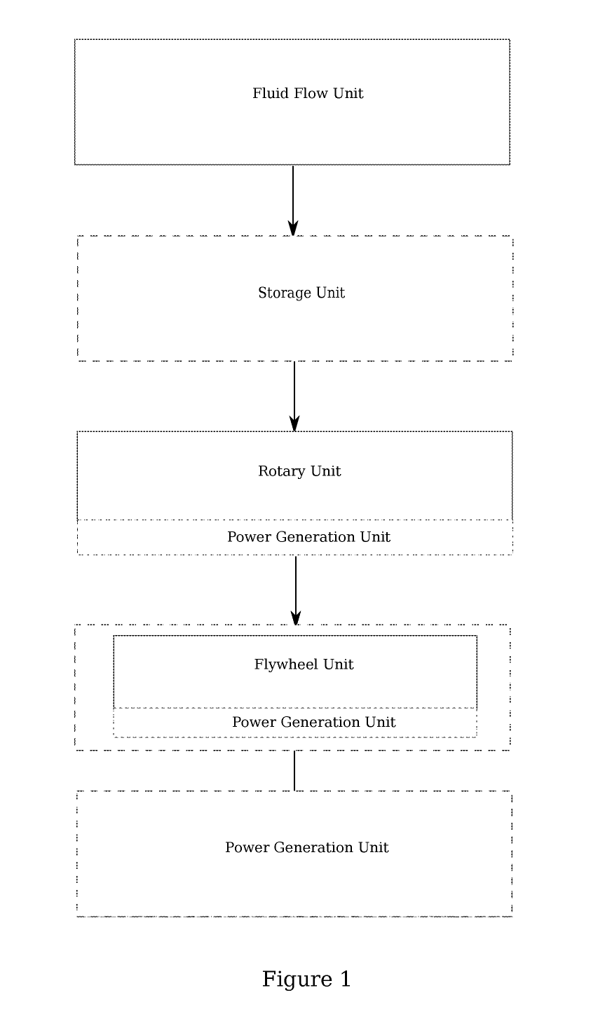

A detailed description of the embodiments will now be given with the aid of the figures. From FIG. 1, five units representing the invention are presented with dashed lines indicating optional units of the system or device.

The Fluid Flow Unit represents both the compressive restorative unit and the flotation-unit, i.e., the pressure-responsive pumping elements, it may also represent an entity which provides a forced flow of fluids, such as the exhaust pipe of a motor vehicle or the water supply of a water sprinkler system.

When compressive restorative units are actuated a restoring force is provided by elastic means to restore it to its initial position but with a flotation-unit the movement of the fluid causes it to move from its initial position and likewise eventually it is restored to its initial position hence both may undergo cyclical action.

The storage unit represents compressed fluid storage, which may include rock storage, or any other suitable fluid-tight container.

The rotary-unit comprises a rotary union mechanism, (which comprises a stationary and rotary part) and a turbine of the radial outflow reaction turbine type; the rotary-unit may further comprise fluid storage integral to the turbine and a power-generator, these elements may be co-located in a single device or distributed as part of a dispersed system.

The integral turbine fluid storage is used to stabilise the compressed fluid supply exiting the turbine and hence smooth the energy supply of the turbine, the turbine can operate with at least one opening, ie., exit vent, from which compressed fluid issues.

The turbine may take any appropriate form, e.g., a blade or a disk (flywheel). The turbine may also be the rotor of a power-generator in which case it would rotate in proximity to magnetic field lines to perform work such as generate electricity. If it takes the form of a flywheel then the energy recovery system may not need a subsequent flywheel.

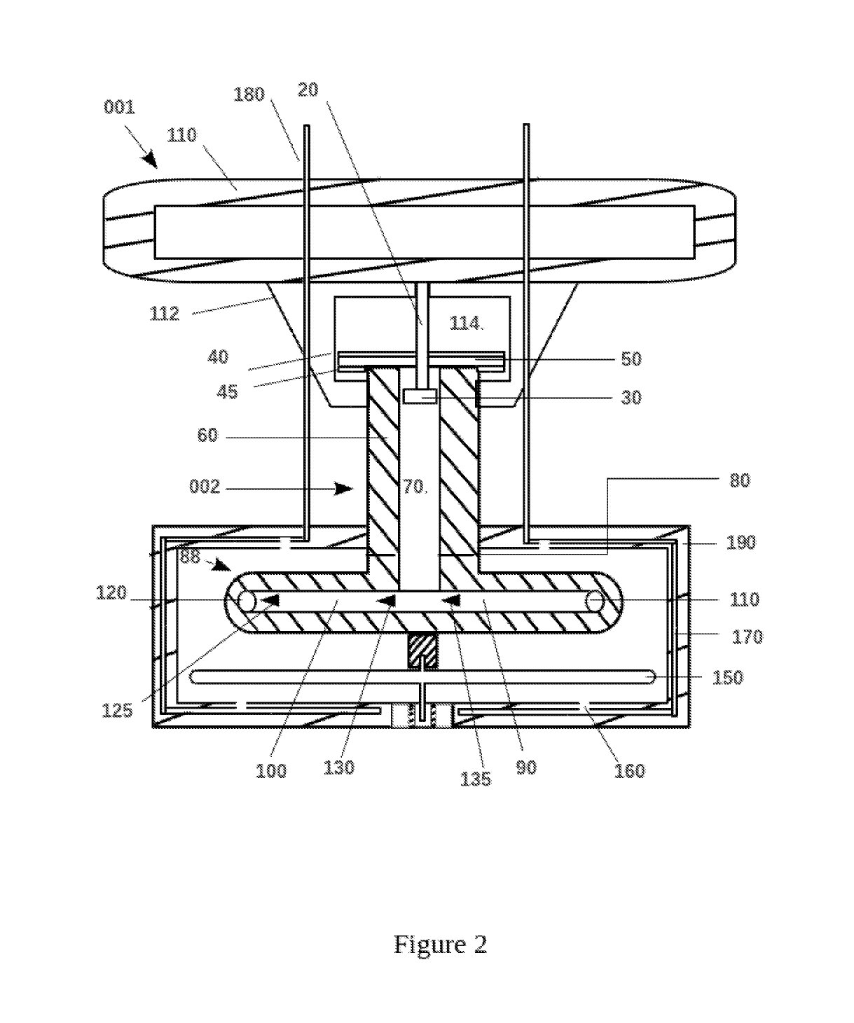

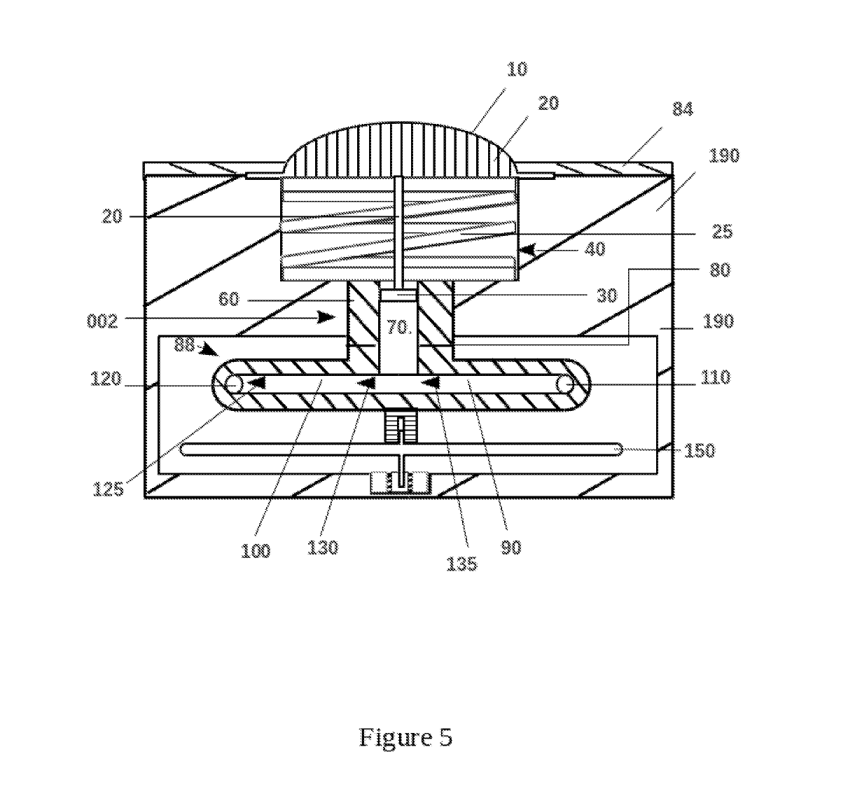

The rotary-unit's operation with the aid of FIGS. 2 and 5 will now be described. The rotary-unit has a stationary enclosure 60 which constitutes the stationary part of said rotary-unit the interior of which is evacuated and forms a stationary axial passage 70, when a piston reciprocates in said passage it is referred to as a piston passage and will be called this from now on since in the preferred embodiments presented the pressure-responsive pumping elements all preferably comprise a piston though it is not necessary for this to be so.

The rotary union mechanism 80 is a fluid tight rotatory mechanism which allows an element to freely rotate relative to a stationary element, e.g., a rotary union joint, said rotary union mechanism 80 lying between the stationary and rotary parts of the rotary unit 002.

The rotary section 80 of the rotary union mechanism begins below and extends further below the interior wall of the preferably cylindrical turbine enclosure 190 then said rotary section extends outward radially, i.e. perpendicular to the stationary axial passage 70, resulting in a disk shaped turbine (a flywheel) 88 having storage cavity 100 and outlet passage 90.

Within the turbine are openings 110 and 120 along its periphery, and one-way valve 130 situated between stationary axial passage 70 and storage cavity 100 said storage cavity 100 being fluidically sealed, until a preset pressure is reached, by one-way valve 125 nearer the opening 120. One way-valve 135 being situated between stationary axial passage 70 and opening 110.

The structure of the turbine may vary within the scope of this application, among other configurations consider the following, assuming we have a turbine with only two openings:

1. There may be no one-way valves at all.
2. There may be single valves pointing only towards the openings.
3. There may be at least one storage cavity.
4. There may be at least one valve pointing towards the center of the turbine.
5. Any combination of the above.

Where none of the valves are used to draw air into the piston passage then alternative paths via which air enters the piston passage may be used. Also, where the opening is used to admit air (fluid) into the turbine the channel opening may advantageously be oriented other than at an angle that causes a turning moment on the turbine, since even though this force is weak and is not expected to stop the turbine from continuing to rotate it still does create some opposition.

If the kinetic energy recovery device is fluidically sealed then the air would be recirculated between air within the turbine enclosure 190 and piston passage 70 during operation.

For the rotary-unit 002 when air is forced down piston passage 70 the air flows through one-way valve 130 into cavity 100 where it exits the turbine 88 at opening 120, the action of the turbine to the issuing air jet is to rotate in reaction to this force in the opposite direction.

Similarly, when air is forced up channel 70 the air is sucked into the turbine at opening 110 into the radial passage 90 and through one-way valve 135, the action of the turbine to the entering air jet is to continue rotating in the same direction as before. (It should be noted that the inlet opening 110 is not necessarily angled to produce a turning moment about the turbine.)

Hence this design is double acting since it continues to function as before on both the up- and down-stroke of the piston, one could even increase its double action capability by exploiting the compressed air above the piston 30 on an upstroke, by for instance having another rotary unit situated above the piston 30 or more conveniently channeling said compressed air down stationary enclosure 60 permitting via one-way valves the entry of said compressed air to storage cavity 100.

The flywheel unit if present would be attached to the rotary-unit which would cause it to rotate

The power generation unit is a power-generator which generates mechanical or electrical energy and may be integral (integrated in) to the rotary unit or flywheel unit (if present); or is, or is not integral to any of the other units but communicates with the turbine 88 or flywheel unit.

Turbine 88 communicates with power-generator 150 permitting the rotary motion of the turbine 88 to be transferred to the rotor of the power-generator 150 which in turn does work.

The power-generator may take the form of an axial- or radial-flux machine; be flat, a pancake (printed circuit) motor or generator, long, or any suitable electrical generator or pump.

It should be noted that these five units of FIG. 1, are not necessarily co-located for example for an ocean application the fluid flow unit may be attached to a platform out at sea, while the storage may be in a reservoir under the ocean floor, and the remainder of the system may be located on land or the entire unit may be basically one co-located device which is moored or floating at sea or fixedly located on the ocean floor either submerged or rising to the sea surface.

Similarly, for a motive traffic application one could have the actuator in the line of traffic for example in the road or the main walkway at a mall whilst the power generation section is on the sidewalk or at a power generation station.

Also, the elements or units of FIG. 1, do not have to be co-axial even when co-located, e.g., the flywheel's radial axis may be perpendicular to the radial axis of the rotary-unit.

In all cases in this application unless explicitly stated or implied by the situation it should not be assumed that the units are co-located. If the elements or units of FIG. 1 are distributed then appropriate fluid transmission means which allows the pressurized fluid to be transmitted to its destination may be used such as: piping (tubing) made of metal, PVC, polymer, composite; nano-technological material, e.g., the single carbon material graphene is being found to have desirable properties including strength; or any combination of these types of materials.

The actuators which may be used in effecting the preferred embodiments will now be described.

### Ocean Energy Embodiment

FIG. 2 will now be used to illustrate this ocean energy embodiment. The flotation-unit essentially comprises a circular hollow float 110 having a centrally located piston-rod 20 extending downwards from it through a rotary unit cap 50 with a piston 30 fixedly attached at its lower end to make a fluid tight seal within the cavity 70. The lower portion of float 110, is a hollow truncated conical section 112 the base of which is configured as circularly spaced radial fins which permit water to easily pass through the base. In the body of the conical section of the float 112 is a cylindrical recess which forms a cylindrical cavity 114. Cavity 114 has the circularly spaced fins as its base, this allows water which may enter cavity 114 to flow in and out easily as the float reciprocates.

The rotary-unit cap 50 is fixedly attached to and lies on top of the stationary part 60 of the rotary-unit 002 also the cap 50 has fixedly attached to its top and underside elastomeric material 40 and 45 respectively, to absorb the shock of the conical section 112 of the flotation unit 001 coming into contact with it as it rises and falls thus limiting the distance of rise or fall of the piston 30 within the piston passage 70 hence protecting piston 30 from damage. If the cap 50 also forms a fluid tight seal then the compressed air above the piston 30 will help to prevent the piston from contacting cap 30.

When actuated the flotation unit 001 causes the piston 30 to reciprocate and force air up and down the piston passage 70 of the rotary-unit 002, i.e., the rotary-unit is actuated which then functions as previously described.

For this embodiment the turbine enclosure 190 is a fluid tight preferably rust proof enclosure. Vents 160 and ducts 170 are arranged to encourage air circulation around the power-generator 150, vents 160 are situated beneath and around the power-generator 150 and also above the turbine 88 to encourage flow of the expected cool expanded air exiting turbine 88.

### Boat-float Actuator

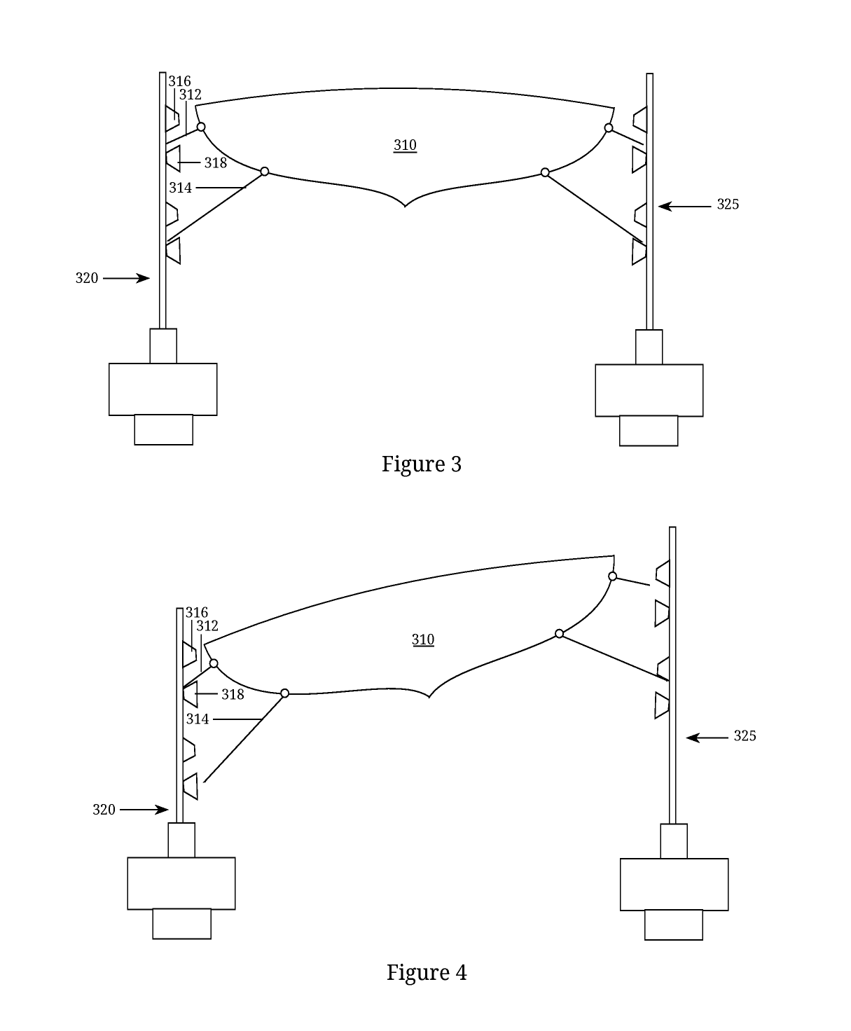

The boat-float system of FIGS. 3 and 4 employs a floating device which exploits, in addition to the lifting forces of the sea, the ability of forces on or beneath the sea surface to impart a rocking motion to it. The boat-float system comprises essentially a boat-float mechanism and an ocean energy conversion device. It may be operated with at least one ocean energy conversion device and also it may be configured to be fixedly attached to the ocean energy conversion device, i.e., it would not necessarily be attached to any other entity including the ocean floor. It may be rotatively attached to a column resting on the ocean floor, this column is not shown, but the details of the boat-float's operation will be made clear.

The boat-float mechanism comprises essentially a float with at least one float actuator and an energy device actuator.

The boat-float mechanism shown in FIGS. 3 and 4 comprises essentially a float 310 which is a body that is influenced by the forces of the sea, it may be either submerged or on the sea surface, with float actuators 312 and 314 attached to it so as to permit its motion to influence another actuator the energy device actuator 325 which in this example is simply a shaft 320 with attached shaft actuators 316 and 318. The shaft 320 may be the piston-rod of an energy conversion device or simply be attached to the piston rod, in this non-limiting embodiment it is the piston rod of the kinetic energy recovery device.

It should be noted that energy device actuators and corresponding energy conversion devices may also be placed along the length of the float 310, not just along its frontal width as shown in FIGS. 3 and 4, hence forming an extended system.

The operation is as follows. The flotation-unit (the boat-float mechanism) shown at rest in FIG. 3 moves with disturbances of the water, if a wave disturbs it, it will move in sympathy with it. In this example assume a wave impacts the boat-float mechanism from the right, then the float 310 heaves as shown in FIG. 4 resulting in its right side rising while its left side descends.

When the right side rises it causes the energy device actuators 312 and 314 in turn to make contact with the shaft actuators 316 and then 318, this causes the piston-rod of the ocean energy conversion device on the right to move upwards. When the wave passes the right side of the float descends and the left side rises this causes the energy device actuators 314 and 312 in turn to make contact with the shaft actuators 318 and then 316, this causes the piston-rod of the ocean energy conversion device on the right to move downwards. The opposite process occurs with the ocean energy conversion device on the left hence the kinetic energy recovery device generates energy as previously described.

### Motive Traffic Embodiment

FIG. 5 will now be used to illustrate the motive traffic embodiment. A compressive restorative unit comprises a fluid-tight cylindrical cavity 40 within enclosure 190 in which is situated a machined spring 25 in communication with cap 20 which has a flat underside and a curved top, said top being lined with an elastomeric membrane 10 which is secured between plate 84 and 190 thus forming a fluid tight seal to enclose cavity 40. Said elastomeric membrane provides traction for the tyres of the motive vehicular traffic. Once depressed by the vehicle the spring 25 causes piston 30 of the rotary-unit 002 to reciprocate hence actuating the rotary-unit 002 which then operates as previously noted.

By placing suitably flat material on top of several of these situated in the path of motive traffic comprised of pedestrians with suitable arrangement electricity may be generated. Among other uses, a device which is pressed to charge its battery may be effected with this embodiment, made small enough it may be used in the keypad of electronic mobile devices.

This embodiment, with a storage means for the produced electricity, may serve as a compact portable emergency supply system, elevator emergency power and lighting system which the occupants of the elevator would operate manually. This embodiment may also serve as a device which is pressed to charge its battery, e.g., an electronic device keyboard energy supply system that recharges the device's battery while it is being used; in exercise machines where one exerts a force (push or pull, or otherwise) which activates the device, to name a few more non limiting examples embodying the present invention.

Consider another embodiment where the kinetic energy recovery device is used as, i.e., configured for use as, a shock absorber of a transport vehicle, the up and down movement of the vehicle while in motion, along with the damping coil (spring) member of the shock absorber, may move a piston via a piston-rod within the length of the shock absorber, i.e., within the damping chamber-hence this will be the compressive restorative unit-causing compressed fluid to move, enter the rotary-unit (whose radial axis may be parallel to the axial passage of the damping chamber, i.e., the piston passage) and ultimately generate energy according to the principles of the invention.

The terms and expressions used throughout this application have been used as terms of description and not of limitation as there is no intention, in the use of such terms and expressions of excluding any equivalents or portions thereof.

Also, it is to be understood that all the embodiments and examples presented in this application, have been provided only by way of exemplification and not of limitation of this invention, and that further configurations, modifications and/or improvements thereto based on what has been disclosed herein and as would be apparent to persons skilled in the relevant art, are deemed to fall within the spirit and ambit of the present invention.

I claim:

1. A kinetic energy recovery device for energy harvesting comprising:
a pressure-responsive pumping element; and a rotary-unit.

2. A kinetic energy recovery device as claimed in claim 1 wherein a power generator ultimately in communication with said rotary-unit generates power.

3. A kinetic energy recovery device as claimed in claim 1 for energy harvesting comprising: a boat-float mechanism for actuating at least one kinetic energy recovery device.

4. A kinetic energy recovery device as claimed in claim 2 for energy harvesting comprising: a boat-float mechanism for actuating at least one kinetic energy recovery device.

5. A kinetic energy recovery device as claimed in claim 1 wherein said kinetic energy recovery device is configured for use as a shock absorber of a motive vehicle.

6. A kinetic energy recovery device as claimed in claim 2 further comprising an enclosure said enclosure having strategically placed vents to encourage ejected cool air currents from the radial outflow reaction turbine to be pulled past the power-generator.

7. I claim a kinetic energy recovery device for energy harvesting comprising:
a compressed fluid store; and a rotary-unit.

8. I claim a radial outflow reaction turbine comprising: at least one cavity enclosed within the body of said turbine, said at least one cavity being fluidically sealed by at least one first one-way valve means and at least one second one-way valve means; said at least one cavity receiving compressed fluid through said at least one first one-way valve means, said compressed fluid exiting said at least one cavity via said at least one second one-way valve means; said exiting compressed fluid causing said turbine to rotate due to the turning moment resulting from said exiting compressed fluid eventually issuing from said turbine.

9. I claim a method for energy harvesting comprising:
(a) generating fluid from at least one pressure-responsive pumping element; and
(b) ultimately communicating said fluid to at least one rotary-unit.
